(19) United States
(12) Patent Application Publication
(10) Pub. No.: US 2006/0093279 A1
(43) Pub. Date: May 4, 2006

(54) Ferrule with weep holes

(75) Inventor: Alan E. Plotts, Harrisburg, PA (US)

Correspondence Address: TYCO ELECTRONICS CORPORATION, 4550 NEW LINDEN HILL ROAD, SUITE 450, WILMINGTON, DE, 19808, US

(73) Assignee: Tyco Electronics Corporation, Middletown, PA (US)

(21) Appl. No.: 10/979,530

(22) Filed: Nov. 2, 2004

(51) Int. Cl. G02B 6/36

(52) U.S. Cl. 385/80

(57) ABSTRACT

A method of preparing a ferrule assembly comprising the steps of: (a) providing a ferrule having a front face, and top and bottom surfaces, and defining a cavity, and the top surface having an access hole to the cavity, the bottom surface defining one or more weep holes in fluid communication with the cavity, the front face defining a plurality of boreholes in fluid communication with the cavity, each borehole adapted to receive a fiber; (b) inserting a plurality of fibers into the boreholes; and (c) applying adhesive to the access hole, thereby causing air in the cavity to vent through at least one of the weep holes. In a preferred embodiment, the amount of adhesive is controlled by observing when adhesive oozes from the weep holes.

### FIELD OF INVENTION

The invention relates generally to fiber optic connectors, and, more specifically, to multi-fiber ferrules used in such connectors.

### BACKGROUND

Optical fiber connectors are a critical part of essentially all optical fiber communication systems. For instance, such connectors are used to join segments of fiber into longer lengths, to connect fiber to active devices such as radiation sources, detectors and repeaters, and to connect fiber to passive devices such as switches and attenuators. The principal function of an optical fiber connector is to optically couple a fiber with the optical pathway of the mating device (e.g., another fiber, an active device or a passive device)-by holding the end of the fiber such that the core of the fiber is axially aligned with the optical pathway of the mating device.

A typical optical fiber connector comprises a ferrule assembly contained within a housing. The ferrule assembly comprises a ferrule, which has one or more boreholes to accommodate fibers, and a fiber secured to each borehole such that the end of the fiber is presented at a mating face of the ferrule for optical coupling to the mating device. Terminating the fiber in the ferrule is a critical step in preparing the ferrule assembly. To this end, the tip of the fiber is stripped to remove its protective polymeric coating, leaving just a “bare fiber.” The bare fiber then is inserted in the borehole in back of the ferrule and pushed forward until the fiber protrudes slightly from the front face of the ferrule. To secure the bare fiber to the borehole, adhesive is applied to a reservoir around the rear opening of the borehole. As the fiber is pushed forward into the borehole, it “draws” the adhesive with it to create the bond with the borehole.

Although this is a relatively simple procedure with a single fiber ferrule, it becomes increasingly more difficult as the number of fibers in the ferrule increase. Specifically, in the case of a multi-fiber ferrule, such as the MT ferrule used in the LIGHTRAY MPX® and MPO connectors, the fibers are densely packed in a fiber array. The high density array makes guiding each fiber into its respective borehole a complex task, particularly for fibers located within the interior of the array. To simplify the procedure, the adhesive is typically added after the fibers are positioned within the boreholes. The fibers are then moved back and forth within the boreholes to draw the adhesive therein.

Unfortunately, as the number and density of the fibers increase, the ability of the adhesive to flow freely and completely around all of the fibers diminishes. Specifically, as the adhesive is applied over the fibers, air bubbles are often trapped at the bottom of the reservoir and cannot escape through the highly viscous adhesive. This results in voids in the reservoir after the adhesive hardens.

These voids present two basic problems. First, they present stress points within the ferrule since air expands and contracts at a different rate than the surrounding adhesive. These stress points in turn stress the fibers contained within the ferrule, leading to diminished optical performance and perhaps to fiber damage. Second, the voids tend to form around fibers and act as a barrier to the adhesive. Since the adhesive does not reach the fiber, it cannot be drawn into the boreholes to secure the fibers thereto. Thus, these voids also compromise the structural integrity of the ferrule assembly.

In the past, various approaches have been taken to eliminate air bubbles within the reservoir and to ensure adequate wetting of the fibers within the boreholes. Specifically, one approach is to apply suction to the front face of the ferrule such that the adhesive is drawn from the back of the boreholes forward to the front face. Although appealing in theory, this approach is complicated, requires specialty equipment, and adds processing steps. Furthermore, often the adhesive is so viscous that suction is inadequate to draw it forward.

Another approach has been to lower the viscosity of the adhesive. Such an approach minimizes the difficulty of drawing the adhesive into the boreholes, but creates new problems with respect to the ferrule leaking adhesive. Specifically, it has been found that lower viscosity adhesives tend to flow freely out of the boreholes, thereby fouling the front face and rear opening of the ferule and even draining the reservoir to create voids, and, hence, the problems as described above.

Therefore, there is a need for a ferrule termination approach which eliminates the formation of air pockets or voids in the ferrule assembly, especially for high density fiber arrays. The present invention fulfills this need among others.

### SUMMARY OF THE INVENTION

The present invention provides for a fiber termination approach which avoids the formation of air pockets within the ferrule assembly by providing weep holes at the bottom of the ferrule. In other words, the ferrule of the present invention is configured to allow air to escape from the bottom of the ferrule rather than out the top through the adhesive. By allowing air to vent from the bottom, the adhesive flows more freely, minimizing the formation of air bubbles and the problems they present. It has also been found surprisingly that the use of weep holes not only reduces the formation of air pockets, but also allows the operator to properly administer the correct amount of adhesive to the ferrule assembly. Adding the proper amount of adhesive is critical—enough adhesive must be added to adequately wet the fibers, but excess adhesive can be messy and foul important reference surfaces of the ferrule. The weep holes of the present invention provide a means of monitoring the amount of adhesive added-this is, when the adhesive begins to ooze from the weep holes, the cavity is sufficiently filled with adhesive.

Accordingly, one aspect of the present invention is a method of terminating fibers in the ferrule using the weep holes to vent air from the bottom of the ferrule. In a preferred embodiment, the method comprises the steps of: (a) providing a ferrule having a front face, and top and bottom surfaces, and defining a cavity, and the top surface having an access hole to the cavity, the bottom of the ferrule defining one or more weep holes in fluid communication with the cavity, the front face defining a plurality of boreholes in fluid communication with the cavity, each borehole adapted to receive a fiber; (b) inserting a plurality of fibers into the boreholes; and (c) applying adhesive to the access hole, thereby causing air in the cavity to vent through at least one of the weep holes. In a preferred embodiment, the amount of adhesive is controlled by observing when adhesive oozes from the weep holes.

Another aspect of the invention is a ferrule having weep holes to vent air during the application of adhesive. In a preferred embodiment, the ferrule comprises a body having a front and back, top and bottom orientation, the body having a front face, a back, and top and bottom surfaces, and defining a cavity adapted to receive a plurality of fibers, the top surface having an access hole to the cavity, the bottom of the body defining one or more weep holes in fluid communication with the cavity, the back having a back opening for receiving the plurality of fibers, the front face defining a plurality of boreholes, each borehole being in fluid communication with the cavity and adapted to receive a fiber.

Yet another aspect of the present invention is a ferrule assembly terminated with fibers having very few if any air bubbles due to the venting of the weep holes. In a preferred embodiment, the terminated ferrule assembly is derived from method described above.

### DETAILED DESCRIPTION OF PREFERRED EMBODIMENT

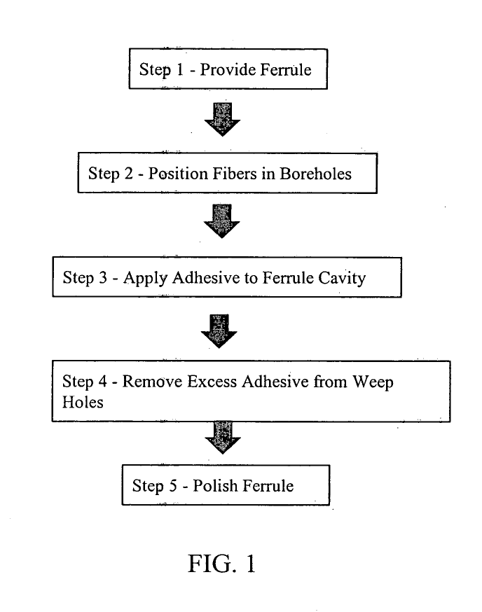

Referring to FIG. 1, a flow chart is shown of a preferred method of terminating fibers in a ferrule in accordance with the present invention. In step 1, a ferrule is provided and has a front face, and top and bottom surfaces, and defines a cavity. The top surface has an access hole to the cavity. The bottom of the ferrule has one or more weep holes in fluid communication with the cavity, and the front face defines a plurality of boreholes in fluid communication with the cavity. Each borehole is adapted to receive a fiber. In step 2, a plurality of fibers is inserted into the boreholes. In step 3, the adhesive is applied to the access hole, causing air in the cavity to vent through at least one of the weep holes. Each of these steps is considered in greater detail below

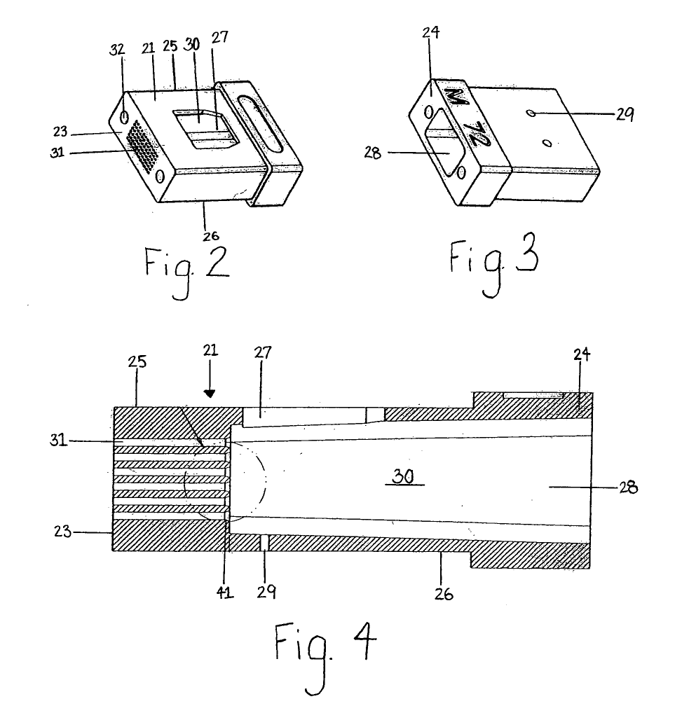

In step 1, the ferrule of the present invention is provided. Referring to FIGS. 2-4, a preferred embodiment of the ferrule 21 is shown. The ferrule 21 comprises a body 21′ having a front and back, top and bottom orientation. The body 21′ has a front face 23, a back 24, and top and bottom surfaces 25, 26. Within the body 21′, a cavity 30 is defined which is adapted to receive a plurality of fibers (not shown). The top surface 25 has an access hole 27 to the cavity 30 to facilitate the injection of adhesive therein. The bottom of the body 21′ has one or more weep holes 29 in fluid communication with the cavity 30 to allow air to vent therefrom. The back 24 has a back opening 28 for receiving the plurality of fibers. The front face defines a plurality of boreholes 31, each borehole being in fluid communication with the cavity 30 and adapted to receive a fiber. Each of the elements of the ferrule is discussed below in greater detail.

With respect to the cavity, its function is to first receive the fibers which are distributed among the fiber boreholes and to provide a reservoir of adhesive to be drawn upon by the fibers as they are “pistoned” back and forth in the boreholes. Accordingly, the cavity must be adequately sized to receive the fibers and to provide a suitable reservoir of adhesive for the fibers. Such cavities are known to those of skill in the art.

Essential to the ferrule of the claimed invention are the weep holes 29. The weep holes allow air to vent from the bottom of the cavity as it is filled with adhesive, thereby allowing the adhesive to flow freely into the cavity. Unlike the prior art in which air bubbles needed to escape upward through the thickened adhesive, with the present invention, the air escapes from the bottom of the ferrule and not through the adhesive. As mentioned above, by providing this alternative escape route for the air, bubbles are minimized in the adhesive which improves the overall performance of the ferrule assembly.

In addition to providing for the egress of trapped air, the weep holes also provide an indication of when the cavity is filled. Specifically, a user can monitor the amount of adhesive added to the ferrule cavity by monitoring the weep holes. When adhesive begins to ooze from the weep holes, the cavity is sufficiently filled with adhesive. This technique is described in greater detail below with respect to Step 3.

The number of weep holes, their size, and their location depend upon a number of factors. First, it is important that the weep holes be large enough to allow air to escape freely, but not be so large as to allow the adhesive to freely flow therefrom. Those of skill in the art in light of this disclosure will be able to determine without undo experimentation the optimum size for a hole given the viscosity of the adhesive. More viscous adhesives will require greater weep hole diameters, while less viscous adhesives will require narrower weep holes. The number of weep holes depends somewhat on their size. Generally two weep holes are desirable at either corner of the cavity, although more may be required depending on their size. Finally, the weep holes should be positioned low in the cavity (i.e., toward the bottom), preferably on the bottom surface, and in areas where the air pockets are likely to form. For example, they should be located in corners or intricacies where air is likely to be trapped by the downward flow of adhesive. In the embodiment shown in FIG. 4, two weep holes are located on the bottom surface toward the front of the cavity just behind the boreholes. This is a particularly preferred location as air pockets in the vicinity of the entrance to the boreholes are particularly problematic as discussed above.

The ferrule 21 has boreholes 31 to receive and hold the fibers precisely therein. The boreholes begin at the cavity and extend out through the front face of the ferrule. It is critical that the boreholes be precisely positioned within the face of the ferrule so as to align the optical axes of the fibers contained therein with those of the mating device. The number of boreholes and the precise position of those boreholes will be dictated by the application. The ferrule assembly of the present invention is particularly well suited for an array of boreholes having columns and rows. In particular, the ferrule assembly is well suited for multiple rows of fibers wherein access to the bottom rows is restricted by the fibers of the rows above. Without weep holes, such a configuration is particularly susceptible to the formation of air bubbles.

The front face of the ferrule assembly, after being polished, becomes the mating face of the ferrule assembly. Accordingly, the front face should be suitable for polishing as is well known in the art. It is also preferable that the front face comprise alignment features for ensuring that the optical axes of the optical fibers are aligned with those of the mating component. With respect to the later feature, it is desirable to restrict the alignment features of the ferrule to the front face and to avoid other reference surfaces about the ferrule. By way of contrast, single fiber ferrules such as those used in the LC and SC connectors align by virtue of the outer surface of the ferrule. Although this alignment feature is suitable for single fiber ferrules, it is undesirable in the present ferrule configuration as such surfaces may be fouled with adhesive. In other words, the top, bottom and side surfaces of the ferrule in the present design need not be precise as they are not used to register the position of the ferrule. Accordingly, adhesive which leaks from the weep holes or flows over from the top access opening can be simply scraped away from these surfaces without regard to diminishing a register surface. Preferably, the ferrule is an MT-type ferrule which comprises alignment pin holes on the front face that are adapted to accept alignment pins which accurately and precisely align the ferrule assembly with the optical axis of the mating component.

In Step 2 a plurality of fibers are inserted into the boreholes. Each borehole receives one and only one fiber. Unlike a single fiber ferrule in which the epoxy is applied about the borehole and then the fiber is introduced, in a multi-fiber ferrule, particularly those containing a fiber array, there is a need to introduce the fiber into the borehole before the adhesive is introduced. Those of skill in the art will appreciate how to prepare and insert a fiber into the borehole. Briefly, the tip of each fiber is stripped to reveal a “bare fiber”. The bare fiber tips are then fed into the boreholes such that they protrude slightly from the front face.

In a preferred embodiment, the boreholes comprise lead-ins 41 which guide the fibers and the epoxy into the boreholes 31. Preferably, the fibers are inserted in the ferrule as described in US patent application 20040042733, hereby incorporated by reference.

In Step 3, the adhesive is added to the cavity until it oozes from the weep holes. The adhesive secures the fibers to the ferrule and eliminates air pockets within the ferrule assembly that can lead to stress points due to thermal expansion differentials in the ferrule assembly. To this end, adhesive is applied to the cavity by way of a syringe or other type of metering device. It needs to be delivered in a measured way so as to allow enough time for the adhesive to flow over the fibers and reach the bottom of the cavity. As mentioned above, unlike the prior art which required the air bubbles to vent at the top of the ferrule assembly through the adhesive, here, weep holes at the bottom of the ferrule provide a vent for any trapped air as the adhesive flows around the fibers.

An additional advantage of the present invention is the ability to observe the weep holes to determine when the cavity is filled. Specifically, when one observes the adhesive beginning to ooze from the weep holes, one can assume that the cavity is filled and discontinue the application of adhesive. (It should be understood that, although it is preferred to stop once the adhesive begins to ooze from the weep holes, it is not required and one can continue to fill the reservoir to the point of overflowing the cavity if desired.) In a preferred embodiment, to enhance operation, it has been found that placement of a mirror under the ferrule during the step of applying the adhesive provides a convenient way for monitoring the weep holes. As mentioned above, the adhesive is applied preferably while moving the fibers back and forth. This back and forth motion “pistons” the fibers within the boreholes which has the tendency of drawing the adhesive from the reservoir and into the boreholes. Preferably this movement is maintained until a layer of adhesive can be observed on the portion of the fibers protruding from the front face of the ferrule.

The adhesive used is preferably a high strength semi-hermetic polymeric material. Suitable adhesives are well known in the art and preferably include epoxies. Particularly preferred epoxies include Tracon F113 and_EpoTEK 353ND.

The result of the above detailed process is a multi-fiber ferrule assembly essentially free of voids in the adhesive. Such a ferrule assembly is therefore ready to be finished. To this end, the excess epoxy which may have oozed from the weep holes can be simply scrapped off in Step 4. As mentioned before, this is not critical since the surface from which it is being scrapped is not a register surface for alignment purposes. Finally, the front face is polished in Step 5 to produce a mating face in accordance with industry standards.

Although the ferrule of the present invention was described with respect to a multi-fiber array ferrule assembly as used with the Xanoptix transceiver having 6 rows and 12 columns (see, for example, U.S. Pat. No. 6,604,866, hereby incorporated by reference), it is not limited to such a ferrule and can be used with any multi-fiber ferrule assembly known in the art or later developed.

What is claimed is:

1. A method of terminating fibers in a ferrule, said method comprising the steps of:
(a) providing a ferrule having a front face, and top and bottom surfaces, and defining a cavity, and said top surface having an access hole to said cavity, said bottom ferrule defining one or more weep holes at the bottom of said cavity in fluid communication with said cavity, said front face defining a plurality of boreholes in fluid communication with said cavity, each borehole adapted to receive a fiber;
(b) inserting a plurality of fibers into said boreholes; and
(c) applying adhesive to said access hole, thereby causing air in the cavity to vent through at least one of said weep holes.

2. The method of claim 1, wherein said ferrule is an MT-type ferrule.

3. The method of claim 1, wherein said weep holes are defined in the bottom surface.

4. The method of claim 2, wherein said one or more weep holes are two weep holes.

5. The method of claim 2, wherein said weep holes are located toward the front of said cavity.

6. The method of claim 1, wherein step (b) is performed prior to step (c).

7. The method of claim 5, wherein in step (c), adhesive is added until adhesive oozes from at least one of said weep holes.

8. The method of claim 7, wherein in step (c), a mirror is placed under the ferrule to observe said adhesive oozing from said weep holes.

9. The method of claim 1, wherein during step (c), said fibers are moved back and forth in said boreholes to urge adhesive into said boreholes.

10. The method of claim 1, wherein said adhesive is epoxy.

11. The method of claim 1, wherein during step (c), the adhesive flows over the fibers.

12. The method of claim 7, wherein after step (c), said excess adhesive around weep holes is removed.

13. The method of claim 12, further comprising: (d) polishing said front face to form a mating surface.

14. A ferrule comprising: a body having a front and back, top and bottom orientation, said body having a front face, a back, and top and bottom surfaces, and defining a cavity adapted to receive a plurality of fibers, said top surface having an access hole to said cavity, said bottom surface defining one or more weep holes in fluid communication with said cavity, said back having a back opening for receiving said plurality of fibers, said front face defining a plurality of boreholes, each borehole being in fluid communication with said cavity and adapted to receive a fiber.

15. The ferrule of claim 14, wherein said ferrule comprises an array of boreholes.

16. The ferrule of claim 15, wherein said array comprises two or more rows of boreholes.

17. The ferrule of claim 14, wherein said cavity is disposed at the back of said boreholes.

18. The ferrule of claim 14, wherein said bottom surface defines said weep holes.

19. The ferrule of claim 14, wherein said weep holes are disposed toward the front of said cavity.

20. The ferrule of claim 14, wherein said ferrule comprises alignment features only on said front face

21. The ferrule of claim 14, wherein said ferrule is an MT-type ferrule.

22. The ferrule of claim 14, wherein further comprising:
a plurality of fibers terminated in said body and held secure by adhesive.

23. The ferrule of claim 22, wherein said front face is a polished, mating face.

24. A terminated ferrule assembly made from the method of claim 1.

25. A terminated ferrule assembly made from the method of claim 12.
